(19) United States
(12) Patent Application Publication
(10) Pub. No.: US 2012/0305716 A1
(43) Pub. Date: Dec. 6, 2012

(54) STAKED STEMMED GLASS HOLDER

(76) Inventors: Robert I. MCKAY, Michigan City, IN (US); David I. McKay, Seattle, WA (US); Therese E. McKay, Seattle, WA (US)

(21) Appl. No.: 13/118,856

(22) Filed: May 31, 2011

(51) Int. Cl. A47G 23/02; F16M 13/00

(52) U.S. Cl. 248/146

(57) ABSTRACT

A glass holder may be placed into the ground for holding one or more glasses. The glass holder may include a framework, a slot, and a glass hole cut-out for holding a glass. The glass holder may also include a rod fitted into the framework that may be placed into the ground.

### BACKGROUND OF THE INVENTION

The present invention generally relates to glass holders and more particularly to staked stemmed glass holders.

Current products may include placing glasses on a circular shape of a stick that is rounded on the top. Another product may resemble a table on the top without slots for glass stems.

As can be seen, there is a need for a glass holder, and more particularly, for a staked stemmed glass holder.

### SUMMARY OF THE INVENTION

In one aspect of the present invention, an apparatus may comprise a framework, at least one slot in the framework; at least one glass hole cut-out within the framework; a rod hole within the framework; and a rod with a rod collar placed within the rod hole.

These and other features, aspects and advantages of the present invention will become better understood with reference to the following drawings, description and claims.

### BRIEF DESCRIPTION OF THE DRAWINGS

FIG. 1 shows a perspective view of an exemplary embodiment of the invention in use;

FIG. 2 shows a top view of the exemplary embodiment of FIG. 1 displaying component framework;

FIG. 3 shows an exploded view of the exemplary embodiment of FIG. 1 of the invention;

FIG. 4 shows a section view of the invention along line 4-4 of FIG. 1;

FIG. 5 shows a perspective view of an alternate embodiment of the invention with component framework;

FIG. 6 shows a top view of the alternate embodiment of FIG. 5;

FIG. 7 shows an exploded view of the alternate embodiment of FIG. 5; and

FIG. 8 shows a section view of the alternate embodiment of FIG. 5 along line 8-8 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a staked stemmed glass holder. The glass holder may securely hold stemmed glasses, prevent spillage, and allow a user's hands to remain free in the outdoors.

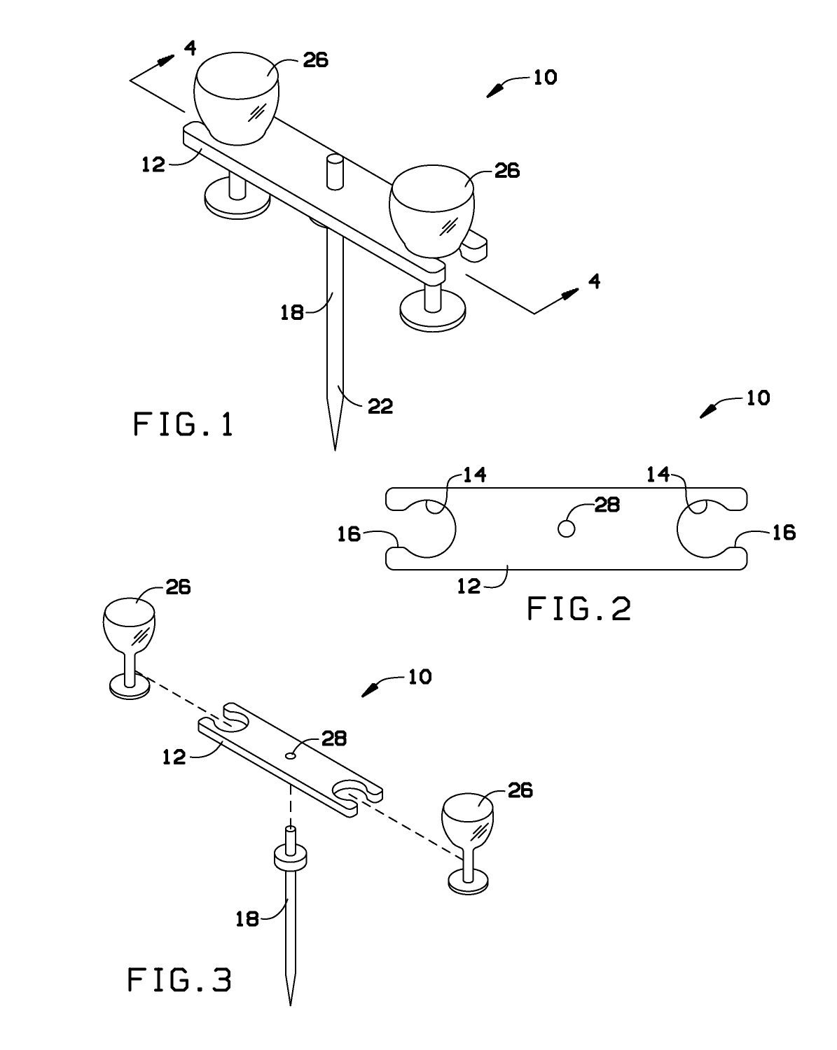

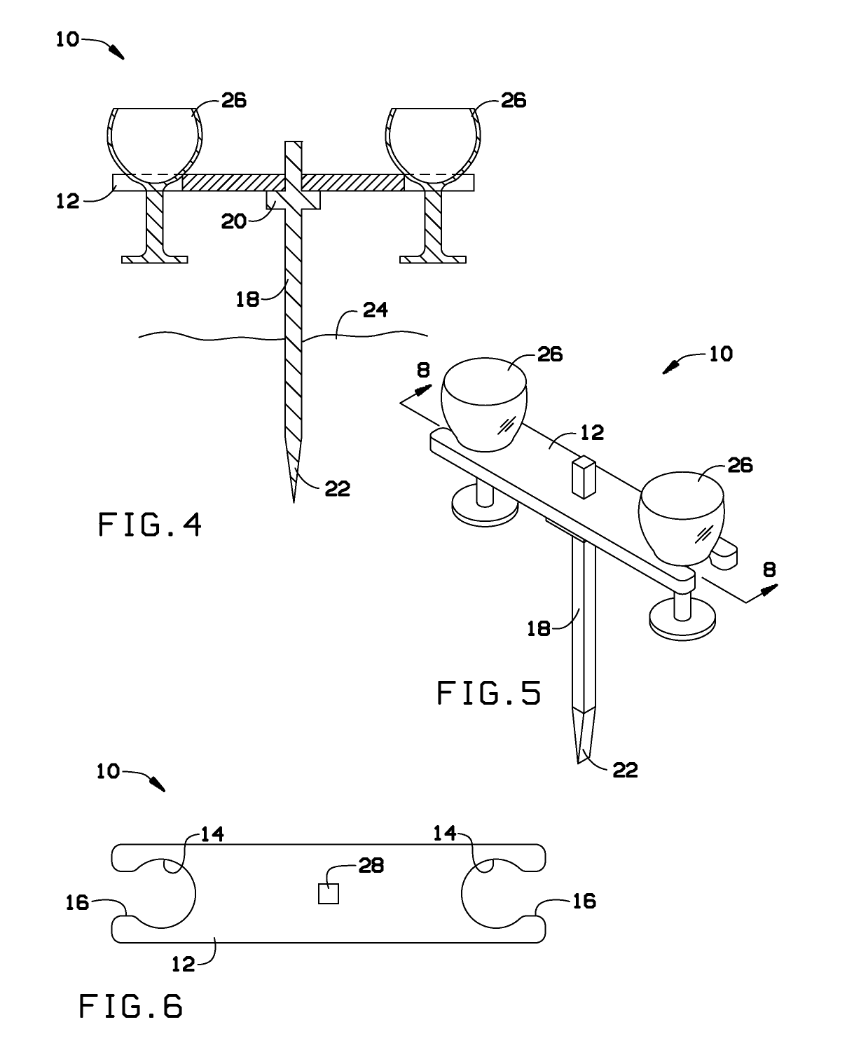

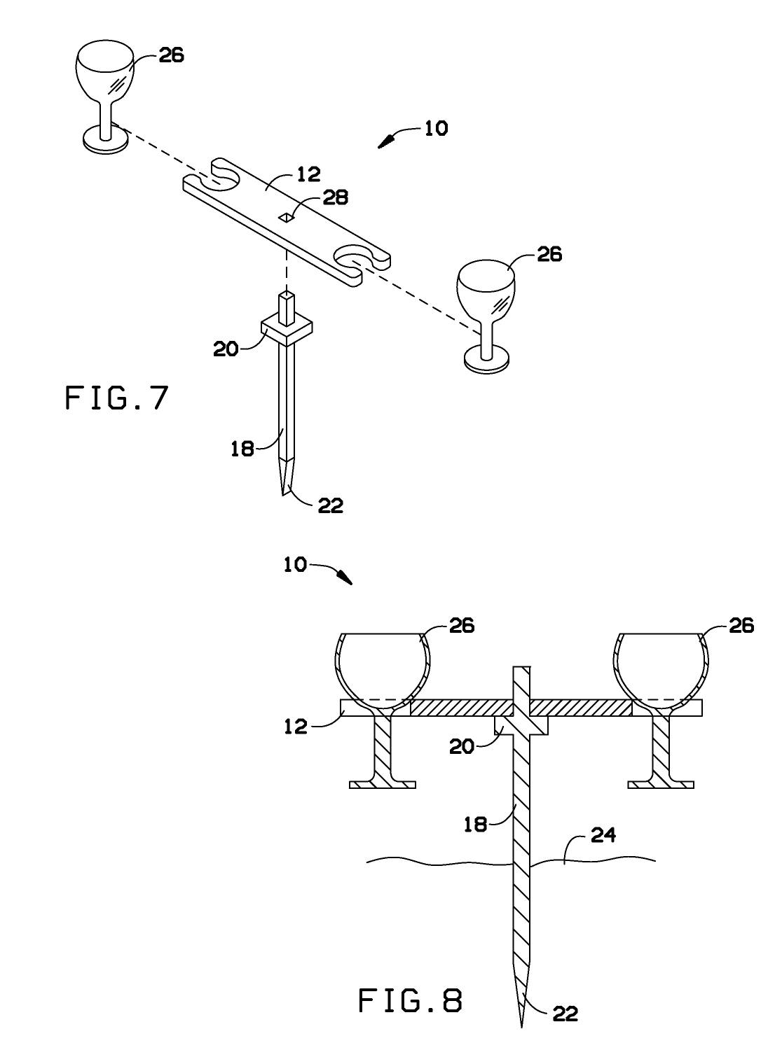

Referring to FIGS. 1 through 8, a glass holder 10 may include a framework 12, a glass hole cut-out 14, a slot 16, a rod 18, a rod collar 20, a sharpened end 22, and a rod hole 28. Referring to FIGS. 1 and 2, a glass 26 may be placed into the framework 12 through the slot 16 into the glass hole cut-out 14. The rod 18 and rod hole 28 may be round. Referring to FIG. 3, the rod 18 may be inserted into the rod hole 28. Referring to FIG. 4, the rod 18, and the sharpened end 22 may be inserted into the ground 24. The rod collar 20 may support the framework 12 and prevent the framework 12 from slipping. Referring to FIGS. 5 and 6, the rod 18 and rod hole 28 may be square.

In an exemplary embodiment of the invention, the framework 12 and rod 18 may fit into picnic baskets and backpacks. The framework 12 and rod 18, including the rod collar 20, may be made of resin or acrylic.

In an exemplary embodiment of the invention, the framework 12, rod 18 and rod collar 20 may be made from clear or solid plastic, wood, resin, stainless steel, or other sturdy materials. The glass holder 10 may be made of various colors.

In an exemplary embodiment of the invention, corners of the framework 12 may be curved and the framework 12 may be made into a figure-8 shape. The framework 12 may also be made into a rectangle, oval, circular, S-shape, U-shape, or crisscross shape. The glass holder 10 may be made of a thin or thick material depending on the strength of the material used and depending how the glass holder may be stored.

In an exemplary embodiment of the invention, the glass holder 10 may be 8 to 10 inches in length. The width of the glass holder 10 may be 2.5 to 4 inches. The rod may be one half inch in diameter and 11 inches in length. The dimensions may be varied depending on the needs of a user. The glass holder 10 may be constructed such that the top of the glass holder 10 may move less than or equal to two inches downward when the glass holder 10 is driven into the ground 24. Stops may be placed at both ends of the rod 16 to prevent travel of the rod 18. An additional table top base may be enable the glass holder 10 on a tailgate, table, concrete ground, or indoors. The rod 18 may be inverted and placed into the base. The rod 18 may be driven into the ground 24 deep enough to prevent the glass holder 10 from tipping from the weight of a glass 26.

In an exemplary embodiment of the invention, the glass holder 10 may be expanded to hold more than two glasses at the same time. Additional slots 16 and glass hole cut-outs 14 may be added. As an example, the slot 16 width or slot 16 length may be narrowed or expanded in a variety of measurements.

In an exemplary embodiment of the invention a firm base may be placed beneath the rod 18. The firm base may be a table, the side of a hot tub, a side of a pool, or flat ground. A clamp or vise like structure may attach the framework 12 to an edge of a table, car window, or tailgate of a motor vehicle. There may be sufficient space between the framework 12 of the glass holder 10 and the ground 24 to allow space for the user's hand to place the glass 26 into the glass holder 10 without touching the ground 24. The glass holder 10 may be fabricated from sturdy material using a hole saw, a saw capable of straight cuts, or a laser.

It should be understood, of course, that the foregoing relates to exemplary embodiments of the invention and that modifications may be made without departing from the spirit and scope of the invention as set forth in the following claims.

What is claimed is:

1. An apparatus comprising:
a framework;
at least one slot in the framework;
at least one glass hole cut-out within the framework;
a rod hole within the framework; and
a rod with a rod collar placed within the rod hole.

2. The apparatus of claim 1 wherein the rod has a sharpened end.

3. The apparatus of claim 1 wherein the framework has at least two slots and at least two glass hole cut-outs.

4. The apparatus of claim 1 wherein the rod is round.

5. The apparatus of claim 1 wherein the rod is square.

6. The apparatus of claim 1 wherein the framework has a crisscross shape.

7. The apparatus of claim 1 wherein the framework, rod, and rod collar are made of clear plastic.

8. The apparatus of claim 1, wherein the framework is made into a figure-8 shape.

9. The apparatus of claim 1, wherein the framework is between 8 and 10 inches in length, and 2.5 to 4 inches in width.

10. The apparatus of claim 9, wherein the rod is one half inch in diameter.
